(19) United States
(12) Patent Application Publication
(10) Pub. No.: US 2026/0202799 A1
(43) Pub. Date: Jul. 16, 2026

(54) PRODUCING A CERAMIC COMPONENT

(71) Applicant: ROLEX SA, Geneva (CH)

(72) Inventor: Pierre Huguet, Allinges (FR)

(73) Assignee: ROLEX SA, Geneva (CH)

(21) Appl. No.: 19/136,441

(22) PCT Filed: Dec. 7, 2023
(86) PCT No.: PCT/EP2023/084803

§ 371 Date: Jun. 6, 2025

(30) Foreign Application Priority Data
Dec. 8, 2022 (EP) 22212285.5

(51) Int. Cl. G04B 45/00; A44C 27/00; G04B 37/22; G04D 3/00

(52) U.S. Cl. CPC G04B 45/0076; A44C 27/00; G04B 37/22; G04D 3/0092

(57) ABSTRACT

The method for producing a zirconia-based part of a timepiece or jewellery component includes: shaping and sintering (E1) the zirconia-based part to obtain the zirconia-based part in its finished or semi-finished shape; then—depositing (E2) a layer including a material that acts as a getter, which has a greater affinity for oxygen than the zirconium of the zirconia-based part, on at least one portion of the surface of the zirconia-based part;—heating (E3) the zirconia-based part in a vacuum atmosphere or a neutral atmosphere to obtain a darkening, or a black or grey coloration, of at least one portion of the zirconia-based part;—removing (E4) the layer including the material that acts as a getter.

### FIELD OF THE INVENTION

The present invention relates to a timepiece or jewelry component comprising at least a portion based on sintered technical ceramic based on zirconia ZrO₂. It also relates to a timepiece comprising such a timepiece component. Finally, it relates to a process for the manufacture of such a portion of a timepiece or jewelry component made of sintered technical ceramic based on zirconia ZrO₂ and to a process for the manufacture of such a timepiece component.

### BACKGROUND ART

In the field of horology, just as in jewelry, it is known to use components made of technical ceramic, which will also be referred to more simply as ceramic. The adjective “technical” refers to the high-performance properties of the chosen ceramics. This is because these technical ceramics can achieve very good mechanical, thermal, indeed even electrical, and/or biochemical properties, and also a chemical inertia and a amagnetism, which render them suitable for use in forming timepiece components, in particular timepiece movement components, but also watch exterior components. The technical ceramics used in this case are distinguished from conventional ceramics by their composition, since they result from purified synthetic powders and not from natural mineral powders, such as, for example, feldspar or kaolin.

Among technical ceramics, ceramics based on zirconia are commonly used because they have good mechanical properties. Besides these mechanical properties, it is advantageous to provide processes for the manufacture of such ceramics which are colored, in particular for esthetic reasons, because zirconia-based ceramics are naturally white. This is because applications in horology and jewelry are also very demanding in terms of esthetic appearance, in particular the color.

### SUMMARY OF THE INVENTION

Thus, a first object of the present invention is to provide a solution for a zirconia-based technical ceramic which makes it possible to achieve a high performance, while making it possible to achieve a desired color, regarded as attractive.

A second object of the present invention is to provide a solution for a zirconia-based technical ceramic which makes it possible for it to be manufactured in a simple manner.

The invention is also more generally concerned with a component comprising a portion made of technical ceramic, it being possible for this technical ceramic to be, for example, based on zirconia or on alumina.

To this end, the invention is based on a process for the manufacture of a zirconia-based portion of a timepiece or jewelry component, wherein it comprises the following stages:
shaping and sintering the zirconia-based portion in order to obtain said zirconia-based portion in its finished or semifinished form, then
depositing a layer comprising a material exhibiting a getter property, exhibiting a greater affinity for the oxygen than the zirconium of said zirconia-based portion, over at least a part of the surface of said zirconia-based portion;
heating said zirconia-based portion under vacuum or in a neutral atmosphere in order to obtain a darkening, indeed even a coloration in black or gray, of at least a part of said zirconia-based portion;
removing said layer comprising the material exhibiting a getter property. This darkening or coloration is visible from a surface of said portion.

The invention is defined more precisely by the claims.

### BRIEF DESCRIPTION OF THE DRAWINGS

These objects, characteristics and advantages of the present invention will be set out in detail in the following description of particular embodiments, given without limitation in connection with the appended figures, among which:

FIG. 1 diagrammatically represents a logical diagram of the process for the manufacture of a portion made of zirconia of a timepiece or jewelry component according to one embodiment of the invention.

FIGS. 2a to 2c diagrammatically represent stages of the manufacturing process according to an example of coloration of a bezel disk according to one embodiment of the invention.

FIGS. 3a to 3d diagrammatically represent stages of the manufacturing process according to an example of coloration of a disc according to one embodiment of the invention.

### DETAILED DESCRIPTION OF PARTICULAR EMBODIMENTS

Subsequently, “dense” ceramic is understood to mean a ceramic, the density of which is between 95% and 100% of the theoretical density of the material under consideration. In this document, the terms “ceramic” or “technical ceramic” denote dense materials based on stabilized zirconium oxide. The terms “portion made of zirconia-based ceramic” or even more simply “zirconia-based portion” will be used to denote a portion made of zirconia-based sintered technical ceramic, forming all or part of a timepiece or jewelry component.

In addition, the term “zirconia-based” or “based on zirconia” is understood to mean a material which in all cases comprises predominantly a zirconia component, in a proportion by weight of at least 50%, indeed even of at least 75%, indeed even of at least 90%. Thus, the ceramic material used by the invention comprises at least 50% by weight of zirconia. A zirconia-based material can also comprise other compounds, in particular without limitation all or part of the compounds chosen from yttrium oxide, cerium oxide, magnesium oxide, calcium oxide, scandium oxide, lanthanum oxide, niobium oxide, ytterbium oxide, neodymium oxide, terbium oxide or erbium oxide.

The term “finished form” of a component or of a portion of a component will be understood to mean a component or a portion of a component, the shape, dimensions and surface finish of which are finalized. The term “semifinished form” will be understood to mean a component or a portion of a component, the shape and the dimensions of which are close to the final form, and the surface finish of which can be different from that which it will have at the end of the manufacturing process.

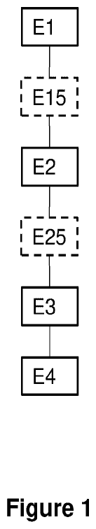

The timepiece or jewelry component comprises at least a zirconia-based portion, that is to say a portion made of sintered technical ceramic based on zirconia ZrO₂. Such a portion can correspond to all or part of the timepiece or jewelry component. The process for the manufacture of such a portion of the timepiece or jewelry component according to one embodiment of the invention comprises the stages represented diagrammatically by the logical diagram of FIG. 1; the optional stages are indicated therein in dotted lines. It makes it possible in particular to manufacture a portion made of zirconia-based ceramic, at least locally black or dark in color, which is considered by the esthetic expert of horology and jewelry as very attractive. This process for the manufacture of a zirconia-based portion according to the invention comprises the following stages:
shaping and sintering E1 said zirconia-based portion in order to obtain said zirconia-based portion in its finished or semifinished form, then
depositing E2 a layer comprising a material exhibiting a getter property over at least a part of the surface of said zirconia-based portion;
heating E3 said zirconia-based portion under vacuum or in a neutral atmosphere in order to obtain, at least locally, that is to say visibly over at least a part, a darkening, indeed even a coloration in black or gray, of said zirconia-based portion; then
removing E4 said layer comprising the material exhibiting a getter property.

As a side note, this manufacturing process thus includes a process for coloring a zirconia-based portion, more particularly formed by the abovementioned stages E2 to E4.

The first stage is carried out starting from a zirconia-based technical ceramic. It comprises beforehand the preparation of a binded ceramic powder, which is shaped and sintered, in a known way, in order to obtain said portion made of zirconia-based technical ceramic. The technical ceramic can be based on yttria-stabilized zirconia, which is optionally pigmented. Thus, the zirconia-based portion resulting from this first stage is a dense technical ceramic, the density of which is between 95% and 100% of the theoretical density of said technical ceramic. According to one embodiment, the sintered technical ceramic comprises a proportion by weight of zirconia ZrO₂ of greater than or equal to 80%, indeed even of greater than or equal to 85%, indeed even of greater than or equal to 90%. According to one embodiment, the sintered technical ceramic comprises a proportion by weight of zirconia ZrO₂ of less than or equal to 94%, indeed even of less than or equal to 93%.

More precisely, the invention can advantageously be applied to an yttria-stabilized zirconia, stabilized with 3 mol % of Y₂O₃, with additions of cerium oxide, or without cerium oxide. In an alternative form, a zirconia stabilized with 2 mol % of Y₂O₃ can be used, indeed even 1.8 mol % of Y₂O₃, indeed even 1.6 mol % of Y₂O₃.

In a further alternative form, the invention can advantageously be applied to an yttria-stabilized and pigmented zirconia, initially having a color other than black; for example, green or blue can be used. For example, the zirconia can advantageously comprise pigments produced starting from spinel, and in particular from cobalt aluminate. Also for example, the zirconia can comprise pigments produced starting from nickel oxide, iron oxide, cobalt aluminate, alumina and/or their mixture. In an alternative form, other ways of coloring the ceramic can be used, such as elements in solid solution, or other. Whatever the way in which the ceramic is colored, its initial color (on conclusion of stage E1) is distinguished from its final color (color obtained on conclusion of stage E4, at least locally modified with respect to the initial color, as will be specified below).

For the implementation of the second stage of deposition of a layer, a material exhibiting an oxygen pump property is chosen, that is to say, in this context, a material exhibiting a greater affinity for the oxygen than the zirconium of the zirconia-based ceramic, in particular at the temperature of the heat treatment which will be described in detail below; this is understood to mean that the oxygen present in the zirconium oxide will have a tendency to diffuse toward this material during the heat treatment applied, rather than to remain in the zirconium oxide. To simplify the description, the term “material exhibiting a getter property” will denote such a material. This is because our application uses a principle similar to that of a non-evaporable oxygen pump (NEG or “non-evaporable getter”), the surface of which adsorbs in particular the oxygen from a vacuum chamber, until it is completely oxidized.

The thickness of this deposited layer can be chosen according to a wide range. Preferably, it will be as thin as possible, the lower limit of the thickness of said layer being defined by the capacity of the material of which it is composed to store a sufficient amount of oxygen extracted from the ceramic. This sufficient amount is defined in particular by its effect on the color finally obtained of the surface of the zirconia-based ceramic, as well as on the depth of ceramic which is darkened relative to the initial color, due to the extraction of oxygen. The thicker this layer of material comprising a getter property, the darker will be the resulting color of the ceramic, until it becomes black, and/or the more this darkened color will extend over a significant depth of the ceramic concerned. The maximum thickness of the layer of this material exhibiting a getter property is additionally defined by the requirement of good adhesion of this layer to the ceramic. This is because a layer which is too thick might encounter problems of adhesion, which might be harmful to its coloration effect over zones of poorer adhesion, and induce a nonhomogeneous coloration, which is not preferred for esthetic reasons. In addition, it should be noted that the effectiveness of the getter property of said material will also depend on its particular structure, a nanocrystalline form increasing for example its storage capacity in comparison with a crystalline form.

Thus, a person skilled in the art will be able to define, on a case-by-case basis, the appropriate parameters of said layer exhibiting a getter property, as a function of the desired result. In general and without limitation, the thickness of this layer can be between 50 nm and 6 μm.

Moreover, the material exhibiting a getter property can be titanium, or a titanium alloy, or hafnium, or a hafnium alloy, or zirconium, or a zirconium alloy, or a combination of these materials, or another more complex material comprising at least one of these materials.

In addition, the stage consisting in depositing E2 a layer comprising a material exhibiting a getter property is advantageously carried out by physical vapor deposition (PVD), or by chemical vapor deposition (CVD), or by atomic layer deposition (ALD), or by pulsed laser deposition (PLD), or any other suitable method.

The material exhibiting a getter property can be deposited over the entire surface of said portion. In an advantageous alternative form, it can be deposited over only a portion of this surface. In this alternative form, a mask can be used to mask the surface part over which the layer is not deposited. It can, for example, be a matter of masking with photosensitive resin (in this case, a layer of resin is deposited over the surface part to be masked) or of “mechanical” masking (in this case, a self-supporting object acting as mask is pressed against the surface part to be masked, indeed even is positioned just above the surface part to be masked). Thus, in this alternative form, the process comprises an intermediate stage consisting in masking E15 at least a part of the surface of said zirconia-based portion of finished or semifinished form, so as to deposit E2 a layer of getter material in a localized manner. In this alternative form, the process also comprises another intermediate stage consisting in removing E25 the mask, after deposition E2 of the getter layer and before the heat treatment E3 of said portion. For the possible case of a mask compatible with the heating stage E3, it might be withdrawn after this stage E3 (for example for a mechanical mask) or during the removal stage E4 (for example for a mask made of resin). In an alternative form, it is possible to envisage any method making it possible to carry out a deposition of getter material in a localized manner over a part of the surface of the portion, even if it does not require carrying out a masking.

Subsequently, the process implements a stage consisting in heating E3 said zirconia-based portion. In this stage, the getter property of the material layer deposited will produce its effect, by absorbing at least a part of the oxygen contained in the ceramic. For this, it is possible to heat said zirconia-based portion to a temperature of between 900° C. and 1300° C., indeed even between 1000° C. and 1150° C.

This heating can be carried out under vacuum, at a pressure of between 10⁻² mbar and 10⁻¹⁰ mbar, or at atmospheric pressure under a neutral atmosphere, based on argon, on xenon or on krypton, or on a mixture of these gases. Any heating condition minimizing the presence of oxygen in the chamber, apart from the ceramic, is advantageous and might be implemented. It is also sought to minimize the presence of carbon, of nitrogen and/or of any element capable of reacting with the zirconia during the process.

It appears that the diffusion of oxygen from the zirconia toward the getter property layer impacts the zirconia-based portion concerned, which becomes at least partly substoichiometric in oxygen (that is to say, depleted in oxygen compared with the initial situation of stoichiometric equilibrium). This change induces, at least locally, a coloration of said zirconia-based portion into black or dark-gray, more generally, at least locally, a darkening of said zirconia-based portion; these modifications occur at the surface and in a zone in the volume of the portion starting from this surface; as these modifications are perceived at the surface of the portion, they are used in particular for decorative purposes. Thus, the coloring process makes it possible preferentially to obtain a black coloration of the ceramic. In an alternative form, it can make it possible to obtain a gray coloration. These black and gray colors are obtained in particular starting from a semifinished or finished component (resulting from the first stage of the process) which is substantially white.

In an alternative form, many other colors are possible. This is because, if the zirconia-based portion comprises coloring pigments, conventionally, it can exhibit any initial color. As a side note, this initial color can, in an alternative form, be obtained by any other process than pigmentation. The ceramic with an initial color is referred to as “pigmented zirconia” or “colored zirconia” in the remainder of the document. The process then makes it possible to darken this initial color. The process thus has the general effect of darkening the treated zirconia-based portion. This darkening resulting from the process according to the invention is due to the fact that the zirconia becomes substoichiometric in oxygen and/or that the pigment is modified. The zirconia-based portion resulting from the process according to the invention will be described as portion “based on zirconia substoichiometric in oxygen exhibiting a darkened appearance”. The coloration according to the invention is carried out in a “subtractive” manner in the sense that the initial chemical composition of the zirconia-based portion is depleted in oxygen and is not enriched in any element (for example, no contribution of carbon is necessary for the coloration). This darkening is thus understood by comparison with the color which would be obtained without the implementation according to the invention (that is to say, the initial color on conclusion of the shaping and sintering stage E1). The coloring process according to the invention can thus make it possible to obtain a darkening, or a black or gray coloration, of the ceramic. Preferentially, the coloring process according to the invention is used to obtain a black coloration of the pigmented zirconia.

The duration of the treatment is highly variable, and depends on the result desired. The heat treatment can be between 10 minutes and 10 hours. Likewise, the temperature of the treatment is highly variable, and depends on the result desired.

As a side note, several alternative embodiments produce different effects. This is because certain alternative embodiments of the invention make it possible to obtain a selective coloration, that is to say one which applies to only a part of the surface of the zirconia-based portion. This can in particular be the case in alternative forms for which the layer comprising a material exhibiting a getter property is not applied over the entire surface of said portion. For example, the coloration according to the invention is selective when it is applied to a zirconia colored by pigments, such as green and blue pigments produced starting from spinel, and in particular cobalt aluminate, or starting from a mixture of oxides (this mixture containing, for example, cobalt aluminate and other oxides), and in the case where the layer comprising a material exhibiting a getter property is not applied over the entire surface of said portion. In this case, only the part of the surface of the portion vertically in line with the locally deposited getter layer is colored according to the principle of the invention. On the other hand, in other alternative embodiments, the coloration according to the invention is observed over the entire surface of the portion of the component, even if its entire surface has not been coated with a layer made of material exhibiting a getter property. This is, for example, the case starting from a portion made of zirconia colored brown with pigments based on ferric oxide Fe₂O₃, as well as made of white yttria-stabilized zirconia containing alumina Al₂O₃, under the conditions tested, for example according to the fourth example which will be described later. In other words, the at least partial application of a layer comprising a material exhibiting a getter property makes it possible, in all cases, to obtain a coloration in a certain volume of the zirconia-based portion, which can correspond exactly to the surface part on which the material exhibiting a getter property is found, that is to say is found directly in line vertically with said surface part over a certain depth, or in an alternative form may not correspond exactly to this surface part and be more extensive. This is due to kinetic reasons of the oxygen diffusion phenomenon. Preferentially, the coloring process according to the invention is used to obtain a selective coloration of the zirconia. And more particularly, the process is preferentially used to obtain a black coloration, selectively visible over the part of the surface which was vertically in line with the locally deposited getter layer, the initial color of the pigmented zirconia being retained over the remainder of the surface.

As a side note, the color of the technical ceramic is measured by spectrophotometry. The measurements are made in reflection with an aperture of 7 mm for a measurement diameter of 4 mm; the geometry of the measuring device corresponds to diffuse illumination and a measurement of the spectra at 8°. If the component does not exhibit a sufficient flat surface, a control disc is used to carry out the measurement. The reflectance measurements are carried out between 360 nm and 740 nm, and the evaluation of the color is carried out with the assumption of an observer at 10° and the illuminant D65. The lightness L* and the chromatic values a* and b*, the chroma C* and the hue angle h* are evaluated in the space defined by the International Commission on Illumination, CIE L*a*b*, as indicated in the “Technical Report of Colorimetry” CIE 15: 2004. The measurements are carried out in SCI (Specular Component Included) and SCE (Specular Component Excluded) modes. In addition, the spectrophotometry measurement is carried out on a component with a polished surface finish, preferably exhibiting a roughness defined by a standardized roughness parameter Ra having the value 2 nm±0.2 nm. As a side note, the parameter Ra is measured according to the standard ISO 4287.

Thus, more precisely, according to the standardized approach explained above, the invention makes it possible to form a timepiece component made of bicolored, indeed even multicolored, ceramic which can comprise at least a dark-colored part, in particular black part, defined by the following colorimetry parameters in SCI mode: L* of less than 47.0, indeed even L* of less than 45.6, indeed even L* of less than 45.4, or L* of between 43.0 and 47.0, indeed even L* of between 44.3 and 45.6, indeed even L* of between 45.0 and 45.4, a* of between −0.1 and 1, indeed even a* of between −0.5 and 1.0, indeed even a* of between 0.3 and 0.9, b* of between −1 and 1.6, indeed even b* of between −0.8 and 1.4, indeed even b* of between 0.3 and 1.1, and L* of between 5.0 and 12.0, a* of between 1.4 and 5.7, b* of between 5.5 and 10.8, in SCE mode, and the other part of which has its original color unmodified.

As a side note, the stages consisting, on the one hand, in depositing a layer comprising a material exhibiting a getter property and, on the other hand, in heating said zirconia-based portion can advantageously be carried out in two separate chambers or in one and the same chamber. In the case where the process comprises an intermediate masking stage mentioned above, this implementation in one and the same chamber remains possible if the masking is appropriately treated.

In this case, the following stages might be treated in one and the same chamber:
depositing E2 a layer comprising a material exhibiting a getter property over at least a part of the surface of said zirconia-based portion;
removing E25 a mechanical masking, optionally (because, in some possible cases, the masking might be removed at a later stage);
heating E3 said zirconia-based portion under vacuum or in a neutral atmosphere in order to obtain a darkening, indeed even a coloration in black or gray, of at least a part of said zirconia-based portion.

The stage consisting in removing E4 the layer comprising the material exhibiting a getter property can be carried out by chemical cleaning, in particular by a chemical dissolution, or mechanical cleaning, in particular by a polishing, sandblasting, machining or brushing stage, of the surface of said portion, possibly involving a laser treatment.

According to one embodiment, the preceding stage consisting in removing E4 the layer comprising the material exhibiting a getter property can make it possible, at the same time, to proceed to the finishing of the surface of the component portion. In an alternative form, the process can comprise an optional separate final finishing stage, for example of rectification and/or of polishing and/or of sandblasting and/or of satin finishing.

As emerges from the preceding description, the zirconia-based portion does not need to contain a getter property material in its volume. Thus, the invention is not applied by incorporating a getter material in the volume, for example during the formulation of the ceramic powder; the getter material is necessarily used in the form of a sacrificial layer added at the surface of the portion. However, according to an alternative embodiment, such a material might be incorporated in the body, in a zone of said portion, for pigmentation purposes, in order to implement a complementary coloration, other than the blackening targeted by this invention.

The manufacturing process thus comprises a phase of coloration of a portion made of zirconia-based ceramic, in particular into black, which additionally exhibits the following advantages:
There is no need to incorporate coloring pigments in the powder, as is commonly done in the state of the art, and even no need for addition of an additional element to the ceramic, for example no need for impregnation with an additional element, as is also done in the state of the art. This is because the coloration according to the invention results directly from a physical phenomenon of modification of the ceramic itself, by oxygen extract;
The result obtained is a portion made of unbroken one-piece ceramic. Specifically, the coloration according to the invention is not obtained either by the addition of a layer of coloration added at the surface, which would risk delaminating;
The coloring phase according to the invention takes place at the end of the manufacturing process, on a semifinished or finished component portion which is already sintered. It can thus be applied in different ways to one and the same semifinished or finished portion, in order to obtain a monochromic or locally (selectively) colored result. It does not require an upstream adaptation of the manufacturing process;
The coloring phase does not require intervention with regard to the initial powder used to manufacture the timepiece component, which forms a simple process because it does not require a powder formulation specific to each color sought;
The coloring phase according to the invention is, in addition, reversible. Thus, in the event of an unsatisfactory result, it is possible to go back by a high-temperature heat treatment (not encountered in the daily life of the watch wearer since it is necessary to reach several hundred degrees in an oxidizing atmosphere) to return to the initial stoichiometric form and possibly to again carry out another phase of coloration with modified parameters. With the coloration solutions of the state of the art, the coloration is irreversible: if the result is not satisfactory, the component is lost and must be discarded, which is thus much less advantageous. The invention also relates to a timepiece or jewelry component resulting from the manufacturing process described above. Thus, the invention relates to a timepiece or jewelry component comprising at least a zirconia-based portion,

wherein it comprises at least a part of the surface of said zirconia-based portion substoichiometric in oxygen exhibiting a darkened, indeed even black or gray, appearance.

Thus, vertically in line with said surface of the zirconia-based portion where the zirconia has a color modified according to the invention, the ceramic exhibits a zone depleted in oxygen. This zone is formed over a certain depth under said surface. This depth can be chosen according to a wide range, defined in part by the layer made of material exhibiting a getter property which is applied during the manufacturing process. In general, this zone is chosen to be sufficiently deep to guarantee that the color is maintained unchanged during the use of the portion of the component, that is to say by preventing in particular the initial color of the zirconia (present under the zone colored by the invention) from appearing, for example as a result of wear by abrasion of the portion, or in the event of scratching of the surface. However, it is advantageously chosen to be relatively thin, in order to avoid complicating the manufacturing process. This depth can, for example, be chosen to be at least 0.015 mm, and preferably between 0.015 mm and 1 mm. In an alternative form, the coloration according to the invention is produced over the total thickness of the component. According to an alternative embodiment, the timepiece or jewelry component can comprise a portion colored in the body by pigments (or colored by any other process), exhibiting a first zone endowed with a first color (the initial color, which is not modified by the invention), and a second zone, exhibiting a second different color (the abovementioned final color induced by the invention), exhibiting said darkened, indeed even black or gray, appearance, as a result of the zone substoichiometric in oxygen induced by the invention.

The zirconia-based portion of the timepiece or jewelry component can be a dense technical ceramic, the density of which is between 95% and 100% of the theoretical density of said technical ceramic.

The darkening, for example the obtaining of the black, gray or more generally dark color according to the invention, can concern only a part of the surface (“selective” coloration) of the portion made of sintered technical ceramic based on zirconia ZrO₂ of said timepiece or jewelry component, or can extend over the entire surface of this portion.

Said zirconia-based portion can be based on yttria-stabilized zirconia which is optionally pigmented, in particular with pigments containing aluminates, in particular cobalt aluminate.

Preferentially, the obtaining of the black color according to the invention concerns only a part of the surface (“selective” coloration) of the portion made of sintered technical ceramic based on pigmented zirconia ZrO₂ of said timepiece or jewelry component, the remainder of its surface retaining its initial color. In such an advantageous alternative form, the process thus makes it possible to obtain a bicolored portion, comprising a first part treated by the invention, black in color, and a second untreated part retaining its initial color, white or of any other color, in particular starting from conventional pigments.

Thus, the invention also relates to a process for the manufacture of a zirconia-based portion of a timepiece or jewelry component which is at least bicolored, which comprises the following stages:
shaping and sintering E1 the zirconia-based portion, which is optionally colored, in particular pigmented, in order to obtain said zirconia-based portion in its finished or semifinished form and in an initial color, then
depositing E2 a layer comprising a material exhibiting a getter property over only a first part of the surface of said zirconia-based portion, a second part remaining uncovered;
heating E3 said zirconia-based portion under vacuum or in a neutral atmosphere in order to obtain a darkening of said zirconia-based portion at said first part, indeed even a coloration in black or gray, said second part retaining its initial color; then
removing E4 said layer comprising the material exhibiting a getter property.

In this process, the second part thus retains its initial color. As a side note, this second part retains not only its initial color but remains even more generally unchanged by the stage consisting in heating the zirconia-based portion.

The timepiece component can be any watch exterior element, such as a bezel, a bezel disk, a case, a back, a middle, a dial, a decorative plate or a bracelet link. In an alternative form, the timepiece component can be a component of a horology movement.

The invention also relates to a timepiece, in particular a wrist watch, which comprises at least one timepiece component as described above.

The timepiece component can be a one-piece component or can comprise the combination of different parts assembled together. Thus, it can be of a single chemical nature or of a combination of chemical natures. It can thus comprise one material or several different materials, including naturally at least a portion made of zirconia-based ceramic as described above.

The portion which it is desired to treat according to the invention, which is monocolored, bicolored or multicolored, is preferably a monobloc form, made of a one-piece portion and, for example, monochromic, with a color referred to as initial color.

The portion treated according to the invention is advantageously at least bicolored. Thus, in the case of a portion treated so as to become bicolored, it is advantageous to obtain a first part which is locally black and a second part which is locally of its initial color. There is then no weak boundary or interface between the black part and the part of the initial color, as would be the case if the two colors were obtained by elements manufactured at least partly separately and subsequently assembled.

In addition, the coloration according to the invention makes it possible to achieve a coloration over a significant depth of the portion, and not only superficially. Thus, in the event of wear at the surface, there is no impact on the color of the portion.

A description will now be given of the manufacture of a technical ceramic according to examples of implementation according to the invention.

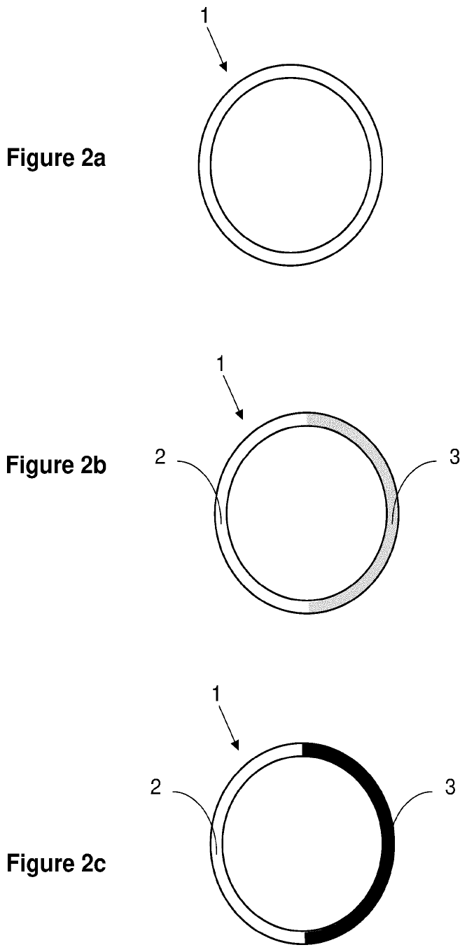

The first example consists of a frustoconical bezel disk made of blue tetragonal zirconia (zirconia stabilized with 3 mol % of Y₂O₃, denoted “3Y ZrO₂”). Its blue color is a coloration in the body obtained by addition of pigments (spinel CoAl₂O₄). The mechanical masking of half of the disk is carried out. The disk is subsequently placed in a PVD deposition chamber where a titanium deposit with a thickness of 5 μm, forming a layer made of material exhibiting a getter property, is produced on its upper surface. The mechanical mask is removed. The disk, thus half-coated, is subsequently placed in a vacuum furnace, where it is subjected to a heat treatment, with a thermal hold at 1035° C. for 30 min, at a pressure of 10⁻⁵ mbar. The getter layer is subsequently removed (by simple brushing) and the disk is polished on its upper surface. The half-disk which was coated with the getter layer henceforth has a black appearance. As a side note, the finished bezel disk does not exhibit a metallic appearance in its part colored according to the invention, which is black. The remainder of the disk remains blue. FIGS. 2a to 2c illustrate diagrammatic views of the upper surface of the bezel disk 1 at different stages of the coloring process according to the embodiment of the invention described above:
FIG. 2a diagrammatically shows the blue monochromic one-piece bezel disk 1, on conclusion of the stage consisting in shaping it and in sintering it E1;
FIG. 2b diagrammatically shows the disk 1, a first half 3 of which is covered with a titanium layer and a second half 2 of which is not, on conclusion of the stage consisting in depositing E2 the titanium layer;
FIG. 2c diagrammatically shows the disk 1, the first half 3 of which has become black while the second half 2 of which has remained blue, on conclusion of the stages consisting in heating E3 and then in removing E4 the titanium layer.

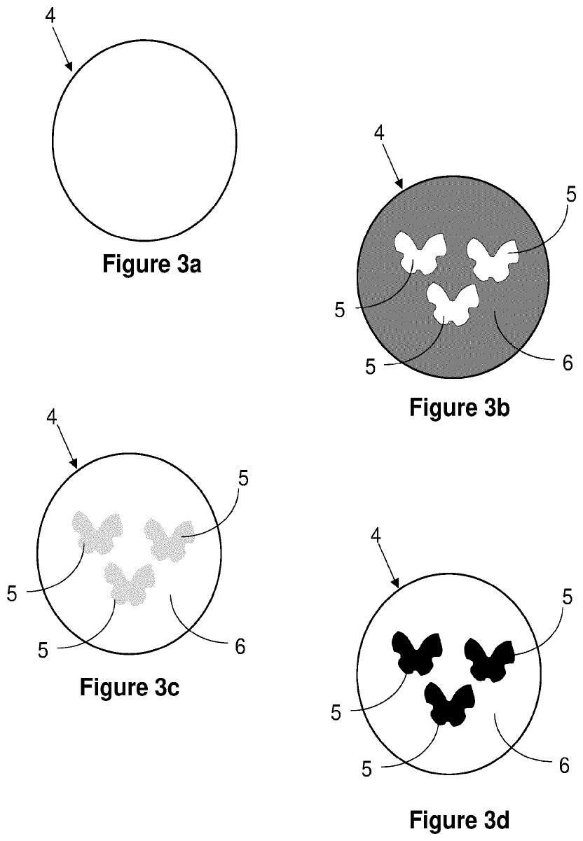

The second implementational example relates to a disc made of blue tetragonal zirconia (3Y ZrO₂), with a diameter of 3 cm and with a thickness of 5 mm. Its blue color is obtained by the addition of pigments (spinel CoAl₂O₄) or by impregnation with cobalt and aluminum salts, according to the teachings of the document CH707424. Its upper surface is polished (which promotes good resolution of the setting). This disc subsequently undergoes masking of a part of its upper surface, carried out using a photosensitive resin, so that the only visible parts of the blue zirconia are on chosen locations, corresponding, for example, to chosen designs, such as, for example, butterfly shapes. The disc is placed in a PVD deposition chamber where a titanium deposit with a thickness of 5 μm, forming a layer made of material exhibiting a getter property, is produced on its upper surface. The masking photosensitive resin is dissolved. The disc, locally coated with titanium, is subsequently placed in a vacuum furnace, where it is subjected to a heat treatment, with a thermal hold at 1035° C. for 30 min, at a pressure of 10⁻⁵ mbar. Finally, the disc is immersed in a suitable chemical solution, which makes it possible to remove the titanium coating. Alternatively, it is subjected to polishing to remove the getter coating. The result obtained is a disc exhibiting a setting consisting of black butterflies on a blue background, the assembly having a polished surface finish. FIGS. 3a to 3c illustrate diagrammatic views of the upper surface of the disc 4 during stages of the coloring process according to the invention:
FIG. 3a diagrammatically shows the blue monochromic one-piece disc 4, on conclusion of the stage consisting in shaping it and in sintering it E1;
FIG. 3b diagrammatically shows the disc 4, a first part 6 of the surface of which is covered with masking resin while second parts 5 are not covered, on conclusion of the intermediate masking stage E15;
FIG. 3c diagrammatically shows the disc 4, the second parts 5 of the surface of which are covered with a titanium layer and the first part 6 of the surface of which is not covered, on conclusion of the stages consisting in depositing E2 a titanium layer and in removing the mask E25;
FIG. 3d diagrammatically shows the disc 4, the first part 6 of the surface of which has remained blue while the second parts 5 of the surface of which are black, on conclusion of the stages consisting in heating E3 and then in removing E4 the titanium layer.

The third example is a bezel disk made of green tetragonal zirconia (3Y ZrO₂). Its green color is a coloration in the body obtained by addition of pigments which are produced from a combination of oxides. Its upper surface is polished. The bezel disk undergoes masking of a part of its upper surface, carried out using a photosensitive resin, so that the visible part of the green zirconia corresponds to half of its surface. The bezel disk is placed in a PVD deposition chamber where a titanium deposit with a thickness of 5 μm, forming a layer made of material exhibiting a getter property, is produced on its upper surface. The masking photosensitive resin is dissolved. The bezel disk, locally coated with titanium, is subsequently placed in a vacuum furnace, where it is subjected to a heat treatment, with a thermal hold at 1035° C. for 30 min, at a pressure of 10⁻⁵ mbar. The bezel disk is subsequently partially subjected to a machining resulting in a satiny surface finish, which makes it possible both to remove the coating made of material exhibiting a getter property and to proceed to the finishing of the surface of this part of the bezel disk. The result obtained is a bezel disk, half of the upper surface of which is satin finishing black and the other half of which is polished green. Alternatively, the machining might be carried out over the entire surface of the disk in order to obtain an entirely satiny, half green and half black, disk.

The fourth example relates to a disc made of white zirconia (containing Al₂O₃), with a diameter of 3 cm and with a thickness of 5 mm. Its upper surface is polished. This disc is placed in a PVD deposition chamber where a titanium deposit with a thickness of 3 μm, forming a getter layer, is produced on its upper surface. The disc, coated with titanium, is subsequently placed in a vacuum furnace, where it is subjected to a heat treatment, with a thermal hold at 1035° C. for 10 min, at a pressure of 10⁻⁴ mbar. Finally, the disc is immersed in a suitable chemical solution (alternatively, it is subjected to polishing), which makes it possible to remove the getter coating. The result obtained is a disc of dark-gray color.

As a side note, in all these examples, the same material exhibiting a getter property, titanium, is used, in order to compare the examples with one another. Naturally, the invention is not limited to titanium, and any other material exhibiting a getter property might in an alternative form be used, as already mentioned above. Likewise, the other parameters chosen in these examples are provided without limitation. It emerges from the entirety of the description that these parameters might vary without departing from the scope of the invention.

The invention also relates to a process for the manufacture of a timepiece component comprising at least a portion based on zirconia-based sintered technical ceramic, wherein the ceramic is bicolored, indeed even multicolored, comprising at least a first treated surface part exhibiting a dark color, in particular a black color, defined by the colorimetry parameters in SCI mode, L* of less than 47.0, indeed even L* of less than 45.6, indeed even L* of less than 45.4, a* of between −0.1 and 1, indeed even a* of between −0.5 and 1.0, indeed even a* of between 0.3 and 0.9, and b* of between −1 and 1.6, indeed even b* of between −0.8 and 1.4, indeed even b* of between 0.3 and 1.1, the spectrophotometry measurement being carried out on a component with a polished surface finish. This component can additionally comprise at least a second untreated surface part of unchanged initial color.

The invention also relates to a timepiece component made of ceramic, wherein it is based on zirconia, wherein it is an unbroken and bicolored, indeed even multicolored, one-piece component, comprising at least a first part in a first color and a second part in a second color different from the first color, in particular comprising a first blue or green color and a second black color.

The invention also relates to a timepiece component made of ceramic resulting from the manufacturing process, wherein it comprises a first part of black color, defined by the colorimetry parameters in SCI mode, L* of less than 47.0, indeed even L* of less than 45.6, indeed even L* of less than 45.4, a* of between −0.5 and 1, indeed even a* of between −0.1 and 1.0, indeed even a* of between 0.3 and 0.9, and b* of between −1 and 1.6, indeed even b* of between −0.8 and 1.4, indeed even b* of between 0.3 and 1.1, the spectrophotometry measurement being carried out on a component with a

polished surface finish. This component can comprise a second untreated surface part of unchanged initial color.

According to the invention, technical ceramics other than the zirconia-based ceramic were tested. It turns out that it is possible to implement the invention identically with other technical ceramics, particularly with an alumina-based ceramic. Thus, all the embodiments described above can be implemented with an alumina-based portion as replacement for a zirconia-based portion.

Thus, the invention also relates to a process for the manufacture of a portion based on technical ceramic, in particular based on alumina, of a timepiece or jewelry component, wherein it comprises the following stages:
shaping and sintering E1 the portion based on technical ceramic in order to obtain said portion based on technical ceramic in its finished or semifinished form, then
depositing E2 a layer comprising a material exhibiting a getter property, exhibiting a greater affinity for the oxygen than the technical ceramic of said portion based on technical ceramic, over at least a part of the surface of said portion based on technical ceramic;
heating E3 said portion based on technical ceramic under vacuum or in a neutral atmosphere in order to obtain a darkening, indeed even a coloration in black or gray, of at least a part of said portion based on technical ceramic;
removing E4 said layer comprising the material exhibiting a getter property.

The invention also relates to a process for the manufacture of a portion based on technical ceramic, in particular based on alumina, of a timepiece or jewelry component which is at least bicolored, wherein it comprises the following stages:
shaping and sintering E1 the portion based on technical ceramic, which is optionally colored, in particular pigmented, in order to obtain said portion based on technical ceramic in its finished or semifinished form and in an initial color, then
depositing E2 a layer comprising a material exhibiting a getter property over only a first part of the surface of said portion based on technical ceramic, a second part of the surface remaining uncovered;
heating E3 said portion based on technical ceramic under vacuum or in a neutral atmosphere in order to obtain a darkening of said portion based on technical ceramic at said first part, indeed even a coloration in black or gray, said second part retaining its initial color; then
removing E4 said layer comprising the material exhibiting a getter property.

The invention also relates to a timepiece or jewelry component comprising at least a portion based on technical ceramic, in particular on alumina, wherein it comprises at least a part of said portion based on technical ceramic substoichiometric in oxygen exhibiting a darkened, indeed even black or gray, appearance.

The invention also relates to a timepiece or jewelry component, wherein said portion based on technical ceramic is a dense technical ceramic, the density of which is between 95% and 100% of the theoretical density of said technical ceramic, and/or wherein said portion based on technical ceramic is based on yttria-stabilized technical ceramic, which is optionally pigmented, in particular with pigments containing aluminates, in particular cobalt aluminate.

1. A process for the manufacture of a zirconia-based portion of a timepiece or jewelry component, wherein the process comprises:
shaping and sintering the zirconia-based portion to obtain the zirconia-based portion in a finished or semifinished form, then
depositing a layer comprising a material exhibiting a getter property, exhibiting a greater affinity for oxygen than zirconium of the zirconia-based portion, over at least a part of a surface of the zirconia-based portion;
heating the zirconia-based portion under vacuum or in a neutral atmosphere to obtain a darkening of at least a part of the zirconia-based portion; and
removing the layer comprising the material exhibiting a getter property.

2. A process for the manufacture of a zirconia-based portion of a timepiece or jewelry component which is at least bicolored, wherein the process comprises:
shaping and sintering the zirconia-based portion to obtain the zirconia-based portion in a finished or semifinished form and in an initial color, then
depositing a layer comprising a material exhibiting a getter property over only a first part of a surface of the zirconia-based portion, a second part of the surface remaining uncovered;
heating the zirconia-based portion under vacuum or in a neutral atmosphere to obtain a darkening of the zirconia-based portion at the first part, the second part retaining an initial color; then
removing the layer comprising the material exhibiting a getter property.

3. The process as claimed in claim 2, wherein the second part of the zirconia-based portion remains unchanged by the heating of the zirconia-based portion.

4. The process as claimed in claim 1, wherein, in the depositing of the layer comprising the material exhibiting the getter property, the layer has a thickness in a range of from 50 nm to 6 μm.

5. The process as claimed in claim 1, wherein the depositing of the layer comprising the material exhibiting the getter property uses, as the material exhibiting the getter property, material selected from the group consisting of titanium, titanium alloy, hafnium, hafnium alloy, zirconium, zirconium alloy, and combinations thereof.

6. The process as claimed in claim 1, wherein the depositing of the layer comprising the material exhibiting the getter property is carried out by physical vapor deposition (PVD), or by chemical vapor deposition (CVD), or by atomic layer deposition (ALD), or by pulsed laser deposition (PLD).

7. The process as claimed in claim 1, wherein the depositing of the layer comprising the material exhibiting the getter property and the heating of the zirconia-based portion are carried out in a same chamber.

8. The process as claimed in claim 1, wherein the process comprises an intermediate masking of a part of the surface of the zirconia-based portion, so that the depositing of the layer comprising the material exhibiting the getter property is carried out on the part of the portion not masked by the intermediate masking.

9. The process as claimed in claim 1, wherein the heating of the zirconia-based portion heats the zirconia-based portion to a temperature in a range of from 900° C. to 1300° C.

10. The process as claimed in claim 1, wherein the heating of the zirconia-based portion is carried out under vacuum at a pressure in a range of from 10⁻² mbar to 10−10 mbar, or under a neutral atmosphere based on argon, on xenon or on krypton.

11. The process as claimed in claim 1, wherein the removing of the layer comprising the material exhibiting the getter property is carried out by chemical cleaning or mechanical cleaning of the surface of the zirconia-based portion.

12. A timepiece or jewelry component comprising at least a zirconia-based portion, wherein at least a part of the zirconia-based portion is substoichiometric in oxygen exhibiting a darkened appearance.

13. The timepiece or jewelry component as claimed in claim 12, wherein
the zirconia-based portion is a dense technical ceramic, a density of which is in a range of from 95% to 100% of a theoretical density of the technical ceramic, and/or
the zirconia-based portion is based on yttria-stabilized zirconia.

14. The timepiece or jewelry component as claimed in claim 12, wherein the zirconia-based portion comprises coloring pigments distributed in a body of the zirconia-based portion, and wherein the zirconia-based portion comprises a first zone colored in the body by the coloring pigments, exhibiting a first color, and a second zone corresponding to the part of the zirconia-based portion which is substoichiometric in oxygen, exhibiting the darkened appearance, exhibiting a second color different from the first color.

15. The timepiece component as claimed in claim 12, wherein
the timepiece component is a watch exterior element, or
the timepiece component is a component of a timepiece movement.

16. A timepiece comprising the timepiece component as claimed in claim 12.

17. The timepiece or jewelry component as claimed in claim 12, wherein the part of the zirconia-based portion which is substoichiometric in oxygen exhibits a black or gray appearance.

18. The timepiece or jewelry component as claimed in claim 12, wherein the zirconia-based portion is based on yttria-stabilized zirconia which is pigmented with pigments containing aluminates.

19. The timepiece or jewelry component as claimed in claim 12, wherein the second color is black or gray.

20. The timepiece component as claimed in claim 12, wherein the timepiece component is a bezel, a bezel disk, a case, a back, a middle, a dial, a decorative plate or a bracelet link.
